(19) United States
(12) Patent Application Publication
(10) Pub. No.: US 2017/0311641 A1
(43) Pub. Date: Nov. 2, 2017

(54) Comestible Comprising Miscanthus Plant Fiber

(71) Applicant: Renew Biomass, LLC, Elmhurst, IL (US)

(72) Inventors: Calvin D. Boender, Elmhurst, IL (US); Dustin J. Dover, Springfield, MO (US)

(21) Appl. No.: 15/581,185

(22) Filed: Apr. 28, 2017

Related U.S. Application Data
(60) Provisional application No. 62/328,969, filed on Apr. 28, 2016.

(51) Int. Cl. A23L 33/22; A23K 10/20; A23K 50/42; A23K 10/30; A23L 13/10

(52) U.S. Cl. CPC A23L 33/22; A23K 10/30; A23L 13/10; A23K 50/42; A23K 10/20; A23V 2002/00

(57) ABSTRACT

This disclosure relates to comestible products, digestive supplements, and meat meal products comprising comminuted Miscanthus plant fiber.

### CROSS-REFERENCE TO RELATED APPLICATIONS

This application claims the benefit of priority of U.S. Provisional Patent Application No. 62/328,969, filed Apr. 28, 2016, which is hereby incorporated herein by reference in its entirety.

### BACKGROUND OF THE INVENTION

### Field of the Invention

This disclosure relates to comestible products, digestive supplements, and meat meal products comprising comminuted Miscanthus plant fiber.

### Description of Related Art

Miscanthus is a genus of African, Eurasian, and Pacific Island plants in the grass family. Miscanthus giganteus, a sterile hybrid of Miscanthus sinensis and Miscanthus sacchariflorus, is a rhizome-propogated C4 perennial grass. Miscanthus giganteus exhibits greater photosynthetic efficiency and lower water use requirements than non-C4 plants, and has very low nutritional requirements. Miscanthus giganteus has a high indigestible fiber content—about 39 wt % to about 44 wt % α-cellulose and about 27 wt % to about 29 wt % lignin (See, e.g., Ververis et al., “Fiber dimensions, lignin and cellulose content of various plant materials and their suitability for paper production,” Industrial Crops and Products 19(3):245-54 (May 2004)).

Indigestible fiber (i.e., crude fiber) is an important part of any human or animal diet. Indigestible fibers such as cellulose and lignin, which are resistant to fermentation in the colon, are considered bulking fibers. Bulking fibers absorb water as they move through the digestive system, easing defecation.

Human and animal comestibles are often supplemented with indigestible fibers through the inclusion of cellulose powder or beet pulp. Beet pulp, while inexpensive (about $0.12-$0.15 per pound), is relatively low in fiber (about 20 wt % fiber). Cellulose powder offers a significantly higher fiber content than beet pulp (about 90 wt % fiber), but requires chemical processing to produce, and is 6-9 times more expensive than beet pulp (about $0.90-$1.10 per pound). There remains a need for an inexpensive fiber source with a high fiber content that can be prepared with minimal processing. In some aspects, there also remains a need for a fiber source with a high fiber content that can be prepared without chemical treatment.

### SUMMARY OF THE INVENTION

It is against the above background that the present invention provides certain advantages and advancements over the prior art.

Although this invention as disclosed herein is not limited to specific advantages or functionalities, the invention provides a comestible product comprising comminuted Miscanthus plant fiber in the range of about 0.5 wt % to about 50 wt %. In some aspects of the comestible product disclosed herein, the comestible product comprises comminuted Miscanthus plant fiber in the range of about 1 wt % to about 20 wt %.

In some aspects of the comestible product disclosed herein, the total crude fiber content of the comestible product is in the range of about 0.3 wt % to about 50 wt %. In some aspects, the total crude fiber content of the comestible product is in the range of about 0.3 wt % to about 25 wt %.

In some aspects of the comestible product disclosed herein, the comminuted Miscanthus plant fiber provides at least about 25 wt % of the total crude fiber content. In some aspects, the comminuted Miscanthus plant fiber provides at least about 40 wt % of the total crude fiber content.

In some aspects of the comestible product disclosed herein, the total protein content is in the range of about 1 wt % to about 75 wt %. In some aspects, the total protein content is in the range of about 1 wt % to about 60 wt %.

In some aspects of the comestible product disclosed herein, the total fat content is in the range of about 1 wt % to about 50 wt %. In some aspects, the total fat content is in the range of about 1 wt % to about 15 wt %.

The invention further provides a dietary supplement product comprising comminuted Miscanthus plant fiber in the range of about 20 wt % to about 99 wt %.

The invention further provides a meat meal product comprising comminuted Miscanthus plant fiber in the range of about 0.5 wt % to about 20 wt %. In some aspects, the meat meal product is a chicken slurry.

In some aspects of the comestible, dietary supplement, or meat meal product disclosed herein, the comminuted Miscanthus plant fiber is obtained from Miscanthus giganteus.

In some aspects of the comestible, dietary supplement, or meat meal product disclosed herein, at least 90 wt % of the comminuted Miscanthus plant fiber has a particle size less than 5 mm.

In some aspects of the comestible, dietary supplement, or meat meal product disclosed herein, the product is an animal consumable product. In some aspects, the animal is a dog or a cat.

The invention further provides a method of feeding animals comprising feeding an animal consumable product to an animal.

The invention further provides a method of feeding a dog or a cat comprising feeding a dog or a cat consumable product to a dog or a cat.

In some aspects of the comestible, dietary supplement, or meat meal product disclosed herein, the product is a human consumable product.

The invention further provides a method of feeding a human comprising feeding a human consumable product to a human.

These and other features and advantages of the present invention will be more fully understood from the following detailed description taken together with the accompanying claims. It is noted that the scope of the claims is defined by the recitations therein and not by the specific discussion of features and advantages set forth in the present description.

### DETAILED DESCRIPTION OF THE INVENTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed products and methods are described, it is to be understood that the aspects described herein are not limited to specific embodiments or configurations, and as such can, of course, vary. It is also to be understood that the terminology used herein is for the purpose of describing particular aspects only and, unless specifically defined herein, is not intended to be limiting.

Definitions and explanations used in the present disclosure are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as moisture content, process parameters, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

In various aspects and embodiments, the disclosure relates to the use of comminuted Miscanthus plant fiber as a crude fiber component in a comestible product. The disclosure demonstrates comminuted Miscanthus plant fiber to be an inexpensive fiber source that is high in fiber and that can be produced with minimal processing. In some aspects, the invention provides a fiber source that can be produced without chemical treatment or processing.

As used herein, the term “comminuted Miscanthus plant fiber” describes any composition of particles or fragments of plant material obtained from of one or more species of the Miscanthus genus, e.g., Miscanthus changii, or Miscanthus depauperatus, or Miscanthus ecklonii, or Miscanthus floridulus, or Miscanthus fuscus, or Miscanthus junceus, or Miscanthus lutarioriparius, or Miscanthus nepalensis, or Miscanthus nudipes, or Miscanthus oligostachyus, or Miscanthus paniculatus, or Miscanthus sacchariflorus, or Miscanthus sinesus, or Miscanthus tinctorius, or Miscanthus villosus, or Miscanthus violaceus. In some embodiments, the plant material is obtained from a hybrid of two species of the Miscanthus genus, e.g., Miscanthus giganteus (Miscanthus sinesis×Miscanthus sacchariflorus).

In some embodiments, the comminuted Miscanthus plant fiber comprises one or more Miscanthus plant derivatives. For example, in some embodiments, the comminuted Miscanthus plant fiber comprises one or more refined Miscanthus isolates, e.g., a Miscanthus isolate having a lowered sugar content.

In some embodiments, the Miscanthus plant fiber is dried before comminution. In some aspects, the water content of the Miscanthus plant fiber before comminution is less than about 50 wt %, e.g., less than about 45 wt %, or less than about 40 wt %, or less than about 35 wt %, or less than about 30 wt %, or less than about 25 wt %, or less than about 20 wt %, or less than about 15 wt %, or is in the range of about 1 wt % to about 50 wt %, or about 2 wt % to about 45 wt %, or about 3 wt % to about 40 wt %, or about 4 wt % to about 35 wt %, or about 5 wt % to about 30 wt %, or about 5 wt % to about 25 wt %, or about 5 wt % to about 20 wt %, or about 5 wt % to about 15 wt %.

As used herein, the term “particle size” refers to the particle size as determined by sieve analysis. Sieve analysis measurements are reported as two sizes—the smallest sieve mesh size that a particle can pass through and the largest sieve mesh size that a particle cannot pass through. Sieve analysis on a particle composition, e.g., comminuted Miscanthus plant fiber, yields the distribution of the composition across a series of particle size ranges. Alternatively, sieve analysis measurements may be reported as a percentage of particles below or above a specified sieve mesh size.

In some embodiments, at least 50 wt % of the comminuted Miscanthus plant fiber has a particle size less than 5 mm, e.g., at least about 55 wt %, or at least about 60 wt %, or at least about 65 wt %, or at least about 70 wt %, or at least about 75 wt %, or at least about 80 wt %, or at least about 85 wt %, or at least about 90 wt %. In some embodiments, at least about 50 wt % or the Miscanthus plant fiber has a particle size less than 4.5 mm, e.g., less than about 4 mm, or less than about 3.5 mm, or less than about 3 mm, or less than about 2.5 mm, or less than about 2.5 mm, or less than about 2 mm, or less than about 1.5 mm, or less than about 1 mm, or less than about 900 μm, or less than about 800 μm, or less than about 700 μm, or less than about 600 μm, or less than about 500 μm, or less than about 400 μm, or less than about 300 μm, or less than about 250 μm, or less than about 200 μm, or less than about 150 μm, or less than about 100 μm, or less than about 50 μm. In some aspects, at least about 60 wt % of the Miscanthus plant fiber has a particle size less than 300 μm, e.g., at least 75 wt % has a particle size less than 300 μm, or at least 50 wt % has a particle size less than 200 μm, or at least 60 wt % has a particle size less than 200 μm, or at least 60 wt % has a particle size between 50 μm and 300 μm, or at least 75 wt % has a particle size between 50 μm and 300 μm.

The person of ordinary skill in the art will appreciate that Miscanthus plant fiber can be comminuted by a variety of means. In some embodiments, Miscanthus plant fiber is comminuted by an extruder, e.g., a screw extruder or a twin-screw extruder. In some embodiments, Miscanthus plant fiber is comminuted by a grinder, e.g., a blade grinder or a propeller grinder. In some embodiments, Miscanthus plant fiber is comminuted by a mill, e.g., a ball mill, or a conical mill, or a disk mill, or a hammer mill. In some aspects, Miscanthus plant fiber is comminuted in an induced air flow hammer mill comprising four interchangeable screens. In some aspects, the Miscanthus plant fiber is comminuted by shearing. The person of ordinary skill in the art will appreciate that the number, size, and organization of hammer mill screens, air flow rate, and Miscanthus plant fiber loading can all be adjusted in order to obtain comminuted Miscanthus plant fiber with a desired particle size distribution, or with one or more desired properties, e.g., lack of detectability in a comestible, appealing texture, etc.

In some embodiments, the crude fiber content of the comminuted Miscanthus plant fiber is maintained at a natural level, i.e., the comminuted Miscanthus plant fiber is essentially untreated. In some aspects, the comminuted Miscanthus plant fiber can be considered “natural,” “100% natural,” “all-natural,” “untreated,” etc.

One embodiment of the disclosure is a comestible product comprising comminuted Miscanthus plant fiber and further comprising one or more additional comestible ingredients. In some aspects, the comestible product comprises comminuted Miscanthus plant fiber in the range of about 0.1 wt % to about 75 wt %, e.g., about 0.1 wt % to about 70 wt %, or about 0.1 to about 65 wt %, or about 0.1 wt % to about 60 wt %, or about 0.25 wt % to about 55 wt %, or about 0.5 wt % to about 50 wt %, or about 0.75 wt % to about 45 wt %, or about 1 wt % to about 50 wt %, or about 1.5 wt % to about 45 wt %, or about 2 wt % to about 40 wt %, or about 2.5 wt % to about 35 wt %, or about 3 wt % to about 30 wt %, or in an amount of about 0.5 wt %, or about 1 wt %, or about 2.5 wt %, or about 5 wt %, or about 7.5 wt %, or about 10 wt %, or about 12.5 wt %, or about 15 wt %, or about 17.5 wt %, or about 20 wt %, or about 22.5 wt %, or about 25 wt %, or about 27.5 wt %, or about 30 wt %, or about 32.5 wt %, or about 35 wt %, or about 27.5 wt %, or about 40 wt %, or about 42.5 wt %, or about 45 wt %, or about 47.5 wt %, or about 50 wt %.

In some aspects, the total protein content of the comestible product is in the range of about 0.5 wt % to about 90 wt %, e.g., about 1 wt % to about 85 wt %, or about 1 wt % to about 80 wt %, or about 1 wt % to about 75 wt %, or about 2.5 wt % to about 70 wt %, or about 5 wt % to about 65 wt %, or 7.5 wt % to about 60 wt %, or about 10 wt % to about 55 wt %, or about 12.5 wt % to about 50 wt %, or about 15 wt % to about 45 wt %, or about 17.5 wt % to about 42.5 wt %, or about 20 wt % to about 40 wt %, or the total protein content is about 10 wt %, or about 12.5 wt %, or about 15 wt %, or about 17.5 wt %, or about 20 wt %, or about 22.5 wt %, or about 25 wt %, or about 27.5 wt %, or about 30 wt %, or about 32.5 wt %, or about 35 wt %, or about 37.5 wt %, or about 40 wt %, or about 42.5 wt %, or about 45 wt %, or about 47.5 wt %, or about 50 wt %.

In some aspects, the total fat content of the comestible product is in the range of 0.5 wt % to about 75 wt %, e.g., about 1 wt % to about 70 wt %, or about 1 wt % to about 65 wt %, or about 1 wt % to about 60 wt %, or about 1 wt % to about 55 wt %, or about 2.5 wt % to about 50 wt %, or about 2.5 wt % to about 45 wt %, or about 2.5 wt % to about 40 wt %, or about 2.5 wt % to about 35 wt %, or about 2.5 wt % to about 30 wt %, or the total fat content is about 1 wt %, or about 2.5 wt %, or about 5 wt %, or about 7.5 wt %, or about 10 wt %, or about 12.5 wt %, or about 15 wt %, or about 17.5 wt %, or about 20 wt %, or about 22.5 wt %, or about 25 wt %, or about 27.5 wt %, or about 30 wt %, or about 32.5 wt %, or about 35 wt %, or about 37.5 wt %, or about 40 wt %.

In some aspects, the total crude fiber content of the comestible product is in the range of about 0.1 wt % to about 70 wt %, e.g., about 0.25 wt % to about 65 wt %, or about 0.5 wt % to about 60 wt %, or about 0.75 wt % to about 55 wt %, or about 1 wt % to about 50 wt %, or about 1.25 wt % to about 45 wt %, or about 1.5 wt % to about 40 wt %, or about 1.75 wt % to about 35 wt %, or about 2 wt % to about 30 wt %, or about 2 wt % to about 25 wt %, or about 2 wt % to about 20 wt %, or about 3 wt % to about 15 wt %, or about 4 wt % to about 10 wt %, or the total crude fiber content is about 1 wt %, or about 1.5 wt %, or about 2 wt %, or about 2.5 wt %, or about 3 wt %, or about 3.5 wt %, or about 4 wt %, or about 4.5 wt %, or about 5 wt %, or about 5.5 wt %, or about 6 wt %, or about 6.5 wt %, or about 7 wt %, or about 7.5 wt %, or about 8 wt %, or about 8.5 wt %, or about 9 wt %, or about 9.5 wt %, or about 10 wt %, or about 11 wt %, or about 12 wt %, or about 13 wt %, or about 14 wt %, or about 15 wt %, or about 16 wt %, or about 17 wt %, or about 18 wt %, or about 19 wt %, or about 20 wt %.

In some aspects, comminuted Miscanthus plant fiber makes up at least 5 wt % of the total crude fiber content of the comestible product, e.g., at least about 7.5 wt %, or at least about 10 wt %, or at least about 12.5 wt %, or at least about 15 wt %, or at least about 17.5 wt %, or at least about 20 wt %, or at least about 22.5 wt %, or at least about 25 wt %, or at least about 27.5 wt %, or at least about 30 wt %, or at least about 35 wt %, or at least about 40 wt %, or at least about 45 wt %, or at least about 50 wt %, or at least about 55 wt %, or at least about 60 wt %, or at least about 65 wt %, or at least about 70 wt %, or at least about 75 wt %, or at least about 80 wt %, or at least about 85 wt %, or at least about 90 wt %, or at least about 95 wt %.

The person of ordinary skill in the art will appreciate that the one or more additional comestible ingredients may be selected from a body of well-known comestible ingredients, based on the type of comestible, in order to obtain a comestible product with one or more desired properties, e.g., appealing texture or flavor, specific protein and/or fat levels, specific protein type, etc. In some embodiments, the comestible product comprises a protein source, e.g., poultry byproduct meal, corn gluten meal, or dried egg product. In some embodiments, the comestible product comprises a starch source, e.g., corn, wheat, or rice. In some embodiments, the comestible product comprises a fat source, e.g., poultry fat. In some embodiments, the comestible product comprises minerals and/or vitamins.

Another embodiment of the disclosure is a dietary supplement product comprising comminuted Miscanthus plant fiber and further comprising one or more additional dietary supplement ingredients. In some aspects, the dietary supplement is intended to provide indigestible fiber to the consumer. In some aspects, the dietary supplement comprises comminuted Miscanthus plant fiber in the range of about 5 wt % to about 99 wt %, e.g., about 10 wt % to about 99 wt %, or about 12.5 wt % to about 99 wt %, or about 15 wt % to about 99 wt %, or about 17.5 wt % to about 99 wt %, or in an amount of about 10 wt %, or about 15 wt %, or about 20 wt %, or about 25 wt %, or about 30 wt %, or about 35 wt %, or about 40 wt %, or about 45 wt %, or about 50 wt %, or about 55 wt %, or about 60 wt %, or about 65 wt %, or about 70 wt %, or about 75 wt %, or about 80 wt %, or about 85 wt %, or about 90 wt %, or about 95 wt %, or about 99 wt %.

In some aspects, the one or more additional dietary supplement ingredients may be selected from a body of well-known functional ingredients, e.g., vitamins, calcium, fatty acids, amino acids, etc. In some aspects, the one or more additional dietary supplement ingredients may be selected from a body of well-known non-functional ingredients, e.g., binders, fillers, texturants, and flavorants. The person of ordinary skill in the art will appreciate that the types and amounts of additional ingredients may be selected in order to obtain a dietary supplement product with one or more desired properties, e.g., health benefit, an appealing texture or flavor, etc.

Another embodiment of the disclosure is a meat meal product comprising comminuted Miscanthus fiber. In some aspects, the meat meal product comprises comminuted Miscanthus fiber in the range of about 0.1 wt % to about 40 wt %, e.g., about 0.1 wt % to about 35 wt %, or about 0.1 wt % to about 40 wt %, or about 0.25 wt % to about 35 wt %, or about 0.25 wt % to about 30 wt %, or about 0.5 wt % to about 25 wt %, or about 0.5 wt % to about 20 wt %, or in an amount of about 0.25 wt %, or about 0.5 wt %, or about 0.75 wt %, or about 1 wt %, or about 1.5 wt %, or about 2 wt %, or about 2.5 wt %, or about 3 wt %, or about 3.5 wt %, or about 4 wt %, or about 4.5 wt %, or about 5 wt %, or about 5.5 wt %, or about 6 wt %, or about 6.5 wt %, or about 7 wt %, or about 7.5 wt %, or about 8 wt %, or about 8.5 wt %, or about 9 wt %, or about 9.5 wt %, or about 10 wt %, or about 12.5 wt %, or about 15 wt %, or about 17.5 wt %, or about 20 wt %, or about 22.5 wt %, or about 25 wt %, or about 27. wt %, or about 30 wt %. In some aspects, the meat meal product is a chicken slurry, a beef slurry, a lamb slurry, a pork slurry, a salmon slurry, or a mixture thereof. In some aspects, the meat meal product does not contain bone or bone meal.

In some embodiments of the disclosure, the comestible food product, dietary supplement, and/or meat meal product disclosed herein are animal consumable products. The person of ordinary skill in the art will appreciate that the animal consumable product may be prepared by any well-known technology, e.g., cooking/heating mixed ingredients, extrusion cooking, emulsion milling, etc. (See, e.g., Waltham Book of Dog and Cat Nutrition, Eg. ATB Edney, Chapter by A. Rainbird, entitled “A Balanced Diet” in pages 57 to 74 Pergamon Press Oxford). In some aspects, the comestible food product is a dog food. One exemplary dog food product embodiment is provided in Table 1A.

TABLE 1A
Dog Food Product Composition

| Ingredient | Range (wt %) |
|---|---|
| Comminuted Miscanthus | 1-20 |
| Plant Fiber | |
| Fat | 1-15 |
| Protein | 1-60 |

Another exemplary dog food product embodiment is provided in Table 1B.

TABLE 1B
Dog Food Product Composition

| Ingredient | Amount (wt %) |
|---|---|
| Comminuted Miscanthus | 8-12 |
| Plant Fiber | |
| Rice | 40 |
| Poultry Byproduct Meal | 25 |
| Corn Gluten Meal | 5 |
| Corn | 10 |
| Dried Egg Product | 4 |
| Poultry Fat | 3 |
| Dry Flavor | 1 |
| Vitamins/Minerals | 0-4 |

One exemplary meat meal product embodiment is provided in Table 2.

TABLE 2
Meat Meal Product Composition

| Ingredient | Range (wt %) |
|---|---|
| Comminuted Miscanthus | 1-20 |
| Plant Fiber | |
| Rendered Meat Meal (10 wt % | 80-99 |
| Moisture) | |

In other embodiments of the disclosure, the comestible food product, dietary supplement, and/or meat meal product disclosed herein are human consumable products. In some aspects, the dietary supplement is a human fiber supplement. One exemplary fiber supplement is provided in Table 3.

TABLE 3
Human Fiber Supplement Composition

| Ingredient | Range (wt %) |
|---|---|
| Comminuted Miscanthus | 1-98 |
| Plant Fiber | |
| Fat | 1-15 |
| Protein | 1-50 |

Another embodiment of the disclosure is a method comprising feeding an animal a comestible product, dietary supplement product, or a meat meal product comprising comminuted Miscanthus plant fiber. In some aspects, the method comprises feeding a dog a comestible product, e.g. a dog food product disclosed in Table 1A or Table 1B.

Another embodiment of the disclosure is a method comprising feeding a human a comestible product, dietary supplement product, or a meat meal product comprising comminuted Miscanthus plant fiber. In some aspects, the method comprises feeding a human a dietary supplement, e.g., a fiber supplement product disclosed in Table 3.

The invention will be further described in the following examples, which do not limit the scope of the invention described in the claims.

### EXAMPLES

The Examples that follow are illustrative of specific embodiments of the invention, and various uses thereof. They are set forth for explanatory purposes only, and are not to be taken as limiting the invention.

### Example 1

### Comminuted Miscanthus Plant Fiber Preparation

Miscanthus giganteus stalks were harvested, stripped of leaves, and allowed to dry until the moisture content of the Miscanthus stalks was in the range of 6 wt % to 12 wt %. Dried stalks were fed into an induced air flow hammer mill equipped with four 0.027 inch screens. Table 4 shows the results of sieve analysis performed on 100 lbs. of the comminuted product.

TABLE 4
Sieve Analysis Results

| Particle Size | | Weight % |
|---|---|---|
| <49 | μm | 9.9% |
| 49-58 | μm | 4.4% |
| 58-81 | μm | 7.6% |
| 81-98 | μm | 21.0% |
| 98-117 | μm | 14.7% |
| 117-138 | μm | 12.2% |
| 138-195 | μm | 8.8% |
| 195-277 | μm | 11.5% |
| >277 | μm | 9.7% |

Desirably, comminuted Miscanthus plant fiber may be provided in a broad range of particle sizes, and accordingly may be tailored to specific products and/or needs (e.g., for a human fiber supplement, for a meat meal composition, for a pet food product, etc.).

### Example 2

### Dog Food Product

A dog food product comprising comminuted Miscanthus plant fiber and further comprising additional comestible ingredients as disclosed in Table 5 is prepared.

TABLE 5
Dog Food Product Composition

| Ingredient | Amount (wt %) |
|---|---|
| Comminuted Miscanthus | 10 |
| Plant Fiber | |
| Rice | 40 |
| Poultry Byproduct Meal | 25 |
| Corn Gluten Meal | 5 |
| Corn | 10 |
| Dried Egg Product | 4 |
| Poultry Fat | 3 |
| Dry Flavor | 1 |
| Vitamins/Minerals | 2 |

The comminuted Miscanthus plant fiber contributes about 7 wt % crude fiber to the dog food product. The dog food product contains protein in an amount exceeding 26 wt %, fat in an amount of about 9%, and a metabolisable energy value of less than 3,100 kcal/kg.

Surprisingly and advantageously, plants of the Miscanthus genus, which naturally have a high indigestible fiber content and can be grown sustainably, can be converted to comestible fiber through a mechanical means such as milling, providing a minimally processed product that may be considered, for example, “all natural.”

Having described the invention in detail and by reference to specific embodiments thereof, it will be apparent that modifications and variations are possible without departing from the scope of the invention defined in the appended claims. More specifically, although some aspects of the present invention are identified herein as particularly advantageous, it is contemplated that the present invention is not necessarily limited to these particular aspects of the invention.

What is claimed is:

1. A comestible product comprising comminuted Miscanthus plant fiber in the range of about 0.5 wt % to about 50 wt %.

2. The comestible product of claim 1, wherein the comestible product comprises comminuted Miscanthus plant fiber in the range of about 1 wt % to about 20 wt %.

3. The comestible product of claim 1, wherein the total crude fiber content is in the range of about 0.3 wt % to about 50 wt %.

4. The comestible product of claim 3, wherein the total crude fiber content is in the range of about 0.3 wt % to about 25 wt %.

5. The comestible product of claim 1, wherein the comminuted Miscanthus plant fiber provides at least about 25 wt % of the total crude fiber content.

6. The comestible product of claim 5, wherein the comminuted Miscanthus plant fiber provides at least about 40 wt % of the total crude fiber content.

7. The comestible product of claim 1, wherein the total protein content is in the range of about 1 wt % to about 75 wt %.

8. The comestible product of claim 7, wherein the total protein content is in the range of about 1 wt % to about 60 wt %.

9. The comestible product of claim 1, wherein the total fat content is in the range of about 1 wt % to about 50 wt %.

10. The comestible product of claim 9, wherein the total fat content is in the range of about 1 wt % to about 15 wt %.

11. The comestible product of claim 1, wherein the comminuted Miscanthus plant fiber is obtained from Miscanthus giganteus.

12. The comestible product of claim 1, wherein at least 90 wt % of the comminuted Miscanthus plant fiber has a particle size less than 5 mm.

13. The comestible product of claim 1, wherein the water content of the comminuted Miscanthus fiber is less than about 20 wt %.

14. The comestible product of claim 1, wherein the product is an animal consumable product.

15. The comestible product of claim 1, wherein the animal is a dog or cat.

16. The comestible product of claim 1, wherein the product is a human consumable product.

17. A dietary supplement product comprising comminuted Miscanthus plant fiber in the range of about 20 wt % to about 99 wt %.

18. A meat meal product comprising comminuted Miscanthus plant fiber in the range of about 0.5 wt % to about 20 wt %.

19. The meat meal product of claim 18, wherein the meat meal product is a chicken slurry.

20. A method of feeding animals comprising providing a product of claim 1 to an animal.

21. The method of feeding animals according to claim 20, wherein the animal is a dog or cat.

22. A method of feeding humans comprising providing a product of claim 1 to a human.
